(19) United States
(12) Patent Application Publication
(10) Pub. No.: US 2026/0246925 A1
(43) Pub. Date: Aug. 20, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); Kia Corporation, Seoul (KR)

(72) Inventors: Jin HEO, Yongin-si Gyeonggi-do (KR); Jungah CHOI, Seoul (KR); Seung Wook PARK, Yongin-si, Gyeonggi-do (KR)

(73) Assignees: HYUNDAI MOTOR COMPANY, Seoul (KR); Kia Corporation, Seoul (KR)

(21) Appl. No.: 19/157,591

(22) PCT Filed: Apr. 5, 2024
(86) PCT No.: PCT/KR2024/004568

§ 371 Date: Aug. 18, 2025

(30) Foreign Application Priority Data
Apr. 7, 2023 (KR) 10-2023-0045953
Apr. 5, 2024 (KR) 10-2024-0046780

(51) Int. Cl. H04N 19/11; H04N 19/136; H04N 19/176; H04N 19/593

(52) U.S. Cl. CPC H04N 19/11; H04N 19/136; H04N 19/176; H04N 19/593

(57) ABSTRACT

According to an embodiment of the present invention provides a method for decoding an image, which includes determining a first prediction block of a current block according to intra template matching mode, determining a second prediction block of the current block according to intra block copy mode, and determining a final prediction block of the current block based on a weighted sum of the first prediction block and the second prediction block.

### TECHNICAL FIELD

The present invention relates to an image encoding/decoding method and apparatus and a recording medium for storing a bitstream. More particularly, the present invention relates to an image encoding/decoding method and apparatus using an intra prediction method and a recording medium for storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

There are various discussions for improving prediction accuracy of intra prediction modes. Especially, for an intra picture to which only intra prediction is applied, inter prediction with relatively higher prediction accuracy is not available, resulting in low coding efficiency. Accordingly, the overall performance of encoding/decoding may be significantly improved by improving prediction accuracy of intra prediction. In particular, various methods are under discussion to improve intra prediction modes such as intra block copy mode and intra template matching mode.

### DISCLOSURE

### Technical Problem

An object of the present invention is to provide a method and apparatus for encoding/decoding an image with improved encoding/decoding efficiency.

Another object of the present invention is to provide a recording medium for storing a bitstream that is generated by generated by a method or apparatus for decoding an image, which is provided in the present invention.

### Technical Solution

A method for decoding an image according to an embodiment of the present invention may include determining a first prediction block of a current block according to intra template matching mode, determining a second prediction block of the current block according to intra block copy mode, and determining a final prediction block of the current block based on a weighted sum of the first prediction block and the second prediction block.

According to an embodiment, a first weight of the first prediction block and a second weight of the second prediction block, which are used to calculate the weighted sum of the first prediction block and the second prediction block, may be selected among a plurality of weight candidates based on weight information obtained from a bitstream.

According to an embodiment, the first weight of the first prediction block and the second weight of the second prediction block, which are used to calculate the weighted sum of the first prediction block and the second prediction block, may be determined according to a prediction mode that is applied to a predetermined reference block adjacent to the current block.

According to an embodiment, when the predetermined reference block is predicted using a prediction mode other than the intra block copy mode or the intra template matching mode, the predetermined reference block may be excluded from determination of the first weight and the second weight.

According to an embodiment, when the predetermined reference block is predicted using a prediction mode other than the intra block copy mode or the intra template matching mode, during the determination of the first weight and the second weight, the predetermined reference block may be considered as being predicted by one of the intra block copy mode and the intra template matching mode.

According to an embodiment, the predetermined reference block may include a top block at a predetermined top position of the current block and a left block at a predetermined left position of the current block, and the first weight and the second weight may be determined according to a prediction mode applied to the top block and a prediction mode applied to the left block.

According to an embodiment, when both the top block and the left block are predicted according to the intra template matching mode, the first weight may have a greater value than the second weight, when both the top block and the left block are predicted according to the intra block copy mode, the second weight may have a greater value than the first weight, and when one of the top block and the left block is predicted according to the intra template matching mode and the other of the top block and the left block is predicted according to the intra block copy mode, the first weight and the second weight may be set to have a same value.

According to an embodiment, the predetermined reference block may include one or more top blocks adjacent to the top of the current block and one or more left blocks adjacent to the left of the current block, and the first weight and the second weight may be determined according to a prediction mode applied to the one or more top blocks and to the one or more left blocks.

According to an embodiment, the first weight and the second weight may be determined to be proportional, respectively, to the number of intra template matching mode blocks and the number of intra block copy mode blocks applied to the one or more top blocks and the one or more left blocks.

According to an embodiment, the first weight of the first prediction block and the second weight of the second prediction block, which are used to calculate the weighted sum of the first prediction block and the second prediction block, may be determined according to a first distortion value of the first prediction block and a second distortion value of the second prediction block.

According to an embodiment, the first distortion value of the first prediction block may be derived based on a difference between the current block and the first prediction block or a difference between a current template of the current block and a reference template that is used to derive the first prediction block. In addition, the second distortion value of the second prediction block may be derived based on a difference between the current block and the second prediction block or a difference between the current template of the current block and a template of the second prediction block.

According to an embodiment, the first weight and the second weight may be determined to be proportional to a reciprocal of the first distortion value and a reciprocal of the second distortion value, respectively.

According to an embodiment, when a larger distortion value between the first distortion value and the second distortion value is greater than a predetermined limit value, a third prediction block that is predicted using a predetermined regular intra prediction mode may be used for determination of the final prediction block, instead of a prediction block corresponding to the larger distortion value between the first prediction block and the second prediction block.

According to an embodiment, the method for decoding the image may further include determining the third prediction block of the current block according to a regular intra prediction mode, and the final prediction block of the current block may be determined based on a weighted sum of the first prediction block, the second prediction block and the third prediction block.

A method for encoding an image according to an embodiment of the present invention may include determining a first prediction block of a current block according to intra template matching mode, determining a second prediction block of the current block according to intra block copy mode, and determining a final prediction block of the current block based on a weighted sum of the first prediction block and the second prediction block.

A non-transitory computer-readable recording medium according to an embodiment of the present invention may store a bitstream generated by the method for encoding an image.

A transmission method according to an embodiment of the present invention may transmit a bitstream generated by the method for encoding an image.

The features briefly summarized above with respect to the present invention are provided as an example only to explain the detailed description and are not construed to limit the scope of the present invention.

### Advantageous Effects

The present invention proposes various embodiments of a method for improving prediction accuracy of intra prediction by combining a prediction block derived based on intra template matching and a prediction block derived based on intra block copy.

In addition, the present invention proposes various embodiments of a method for improving prediction accuracy of intra prediction by combining a prediction block generated from an intra prediction mode, a prediction block derived based on intra template matching, and a prediction block derived based on intra block copy.

According to the various embodiments, since prediction accuracy of intra prediction is improved, overall coding efficiency can be improved.

### DESCRIPTION OF DRAWINGS

FIG. 1 is a block diagram showing a configuration of an encoding apparatus according to an embodiment of the present disclosure.

FIG. 2 is a block diagram showing a configuration of a decoding apparatus according to an embodiment of the present disclosure.

FIG. 3 is a diagram schematically showing a video coding system to which the present disclosure is applicable.

FIG. 4 shows a method for deriving a first prediction block based on intra template matching and a method for deriving a second prediction block based on intra block copy.

FIG. 5 shows a current block and a reference block referenced by the current block.

FIG. 6 is a flowchart showing an embodiment of an intra prediction method according to the present invention.

FIG. 7 exemplary illustrates a content streaming system to which an embodiment according to the present disclosure is applicable.

### BEST MODE

A method for decoding an image according to an embodiment of the present invention may include determining a first prediction block of a current block according to intra template matching mode, determining a second prediction block of the current block according to intra block copy mode, and determining a final prediction block of the current block based on a weighted sum of the first prediction block and the second prediction block.

### MODE FOR INVENTION

The present disclosure may have various modifications and embodiments, and specific embodiments are illustrated in the drawings and described in detail in the detailed description. However, this is not intended to limit the present disclosure to specific embodiments, but should be understood to include all modifications, equivalents, or substitutes included in the spirit and technical scope of the present disclosure. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present disclosure with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present disclosure, the terms first, second, etc. may be used to describe various components, but the components should not be limited by the terms. The terms are only used for the purpose of distinguishing one component from another. For example, without departing from the scope of the present disclosure, the first component may be referred to as the second component, and similarly, the second component may also be referred to as the first component. The term is and/or includes a combination of a plurality of related described items or any item among a plurality of related described items.

The components shown in the embodiments of the present disclosure are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present disclosure as long as they do not deviate from the essence of the present disclosure.

The terminology used in the present disclosure is only used to describe specific embodiments and is not intended to limit the present disclosure. The singular expression includes the plural expression unless the context clearly indicates otherwise. In addition, some components of the present disclosure are not essential components that perform essential functions in the present disclosure and may be optional components only for improving performance. The present disclosure may be implemented by including only essential components for implementing the essence of the present disclosure excluding components only used for improving performance, and a structure including only essential components excluding optional components only used for improving performance is also included in the scope of the present disclosure.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present disclosure will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and

can be used interchangeably.

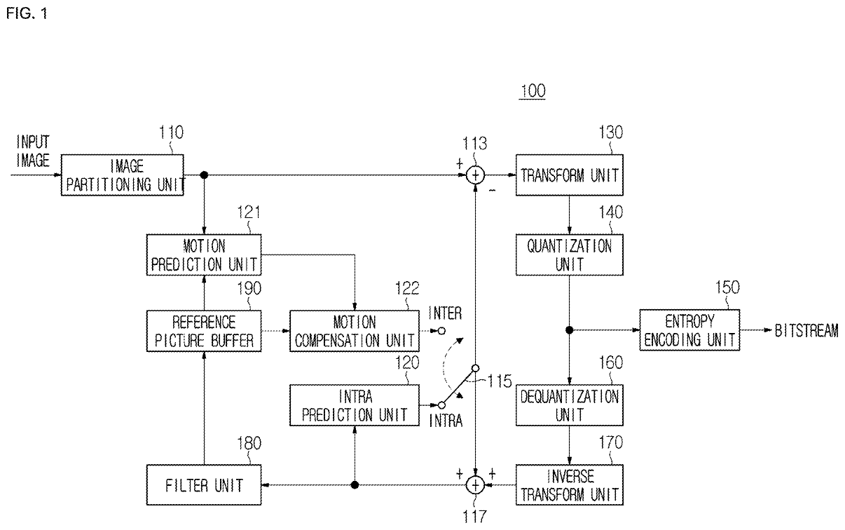

FIG. 1 is a block diagram showing a configuration of an encoding apparatus according to an embodiment of the present disclosure.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present disclosure, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

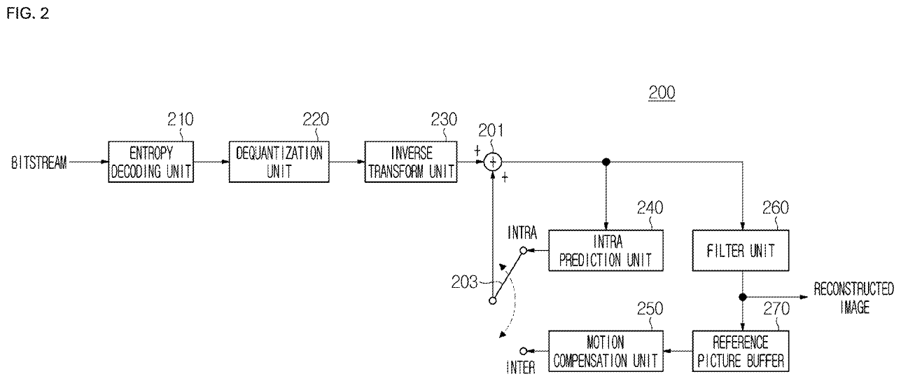

FIG. 2 is a block diagram showing a configuration of a decoding apparatus according to an embodiment of the present disclosure.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

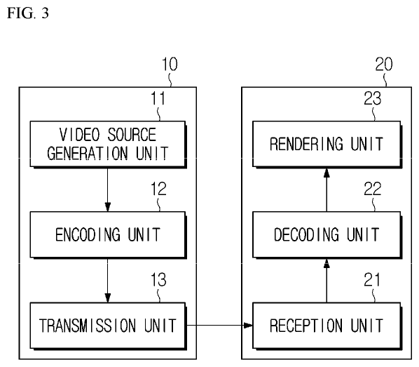

FIG. 3 is a diagram schematically showing a video coding system to which the present disclosure is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

The present invention describes a method for improving accuracy of intra prediction by using intra prediction techniques of intra template matching (IntraTMP) and intra block copy (IBC). IntraTMP and IBC are techniques that search for a prediction block for a current block within areas that have already been reconstructed. According to the proposed method of the present invention, accuracy of intra prediction may be improved by generating a final prediction block from a combination of a prediction block derived based on IntraTMP and a prediction block derived based on IBC.

Hereinafter, a method is described in which a current block is predicted by combining a first prediction block, which is derived from IntraTMP, and a second prediction block, which is derived from IBC.

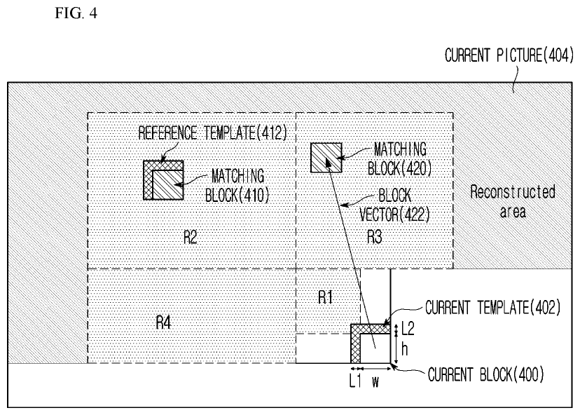

FIG. 4 shows a method for deriving a first prediction block based on intra template matching and a method for deriving a second prediction block based on intra block copy.

Intra template matching is a method for deriving a prediction block based on a reference template 412 corresponding to a current template 402 of a current block 400. According to FIG. 4, the current template 402 with a predetermined form is derived from a neighboring reference sample of the current block 400. In addition, the reference template 412, which is most similar to the current template 402, is derived from a reconstructed area of the current picture 404. Next, a prediction block of the current block 400 is determined based on a matching block 410 corresponding to the derived reference template 412.

In FIG. 4, the current template 402 has a ‘-’ shape that includes both a left reference sample and a top reference sample of the current block 400. However, according to an embodiment, the current template 402 may be configured to include only the left reference sample of the current block 400 or to include only the top reference sample of the current block 400. L1 and L2 of the current template 402 refer to widths of samples included in the current template 402, and each of L1 and L2 is a positive integer. That is, the current template 402 may include not only a reference sample immediately adjacent to the current block 400 but also a reference sample spaced apart from the current block 400 by a predetermined sample unit.

Accordingly, when intra template matching is applied to the current block 400, information indicating the application of intra template matching is encoded in an encoder. In addition, a decoder may receive the information and perform intra template matching for a current block by a same method as that of the encoder, and thus the decoder and the encoder may generate a same prediction block.

Intra block copy is a method that determines a block vector 422 within a predefined search range of a reconstructed area of the current block 400 and derives a prediction block of the current block 400 according to the block vector 422.

In an encoder, the matching block 420, which is most similar to the current block 400, is found within a predefined search range (R1, R2, R3 and R4) of a reconstructed area. In addition, the block vector 422 representing the displacement between the current block 400 and the matching block 420 is derived. In addition, the block vector 422 may be encoded based on block vector information of a neighboring block of the current block 400.

A decoder may derive the block vector 422 of the current block 400 from the block vector information of the current block 400 by referring to a block vector of a neighboring block of the current block 400. In addition, the matching block 420 of the current block 400 is determined based on the block vector 422, and a prediction block of the current block 400 is derived according to the matching block 420.

A predefined search range of intra template matching and intra block copy may include current coding tree block R1, top-left coding tree block R2, top coding tree block R3, and left coding tree block R4. However, this is merely one example, and apart from the above-described search range, a search range may be determined to have an arbitrary size.

A prediction block derived by the above-described intra template matching is defined as a first prediction block, and a prediction block derived by the intra block copy is defined as a second prediction block. In order to improve accuracy of intra prediction, a final prediction block of a current block may be generated by a weighted sum of the first prediction block and the second prediction block that are derived by the two methods. Hereinafter, Equation 1 shows a method for generating a final prediction block by a weighted sum of a first prediction block, which is derived by intra template matching, and a second prediction block, which is derived by intra block copy.

$$P = {W}_{IntraTMP} \times {P}_{IntraTMP} + {W}_{IBC} \times {P}_{IBC} \qquad [ Equation 1 ]$$

In Equation 1, P_{IntraTMP} and P_{IBC} mean a prediction value of a first prediction block based on intra template matching and a prediction value of a second prediction block based on intra block copy, respectively. W_{IntraTMP} and W_{IBC} mean a weight of the first prediction block based on intra template matching and a weight of the second prediction block based on intra block copy, respectively. The weights satisfy W_{IntraTMP}+W_{IBC}=1, W_{IntraTMP}≥0, and W_{IBC}≥0.

According to an embodiment, a final prediction block may be generated by a weighted sum of K first blocks derived based on intra template matching and one second prediction block derived based on intra block copy. Herein, the K prediction blocks derived according to intra template matching may be determined in ascending order of distortions of templates. Herein, K is an arbitrary positive integer.

According to an embodiment, K first prediction blocks and one second prediction block may have a same weight. Alternatively, the sum of weights of the K first prediction blocks may be set to be equal to a weight of the one second prediction block. In addition, a same weight may be set for each of the K first prediction blocks. Alternatively, a different weight may be set for each of the K first prediction blocks according to a distortion of a template. For example, a small weight may be given to a first prediction block that is generated from a template with a large distortion value. The distortion of the template may be calculated by using various correlation measurement methods such as the sum of absolute differences (SAD) or the sum of square error (SSE).

According to an embodiment, weight W_{IntraTMP} of a first prediction block according to intra template matching and weight W_{IBC} of a second prediction block according to intra block copy may be determined as arbitrary weights that are preset at an encoder and a decoder.

Alternatively, weight W_{IntraTMP} of a first prediction block and weight W_{IBC} of a second prediction block may be determined among N predefined weight candidates. Herein, the encoder may transmit index information indicating a weight candidate applied to a current block among the N weight candidates, and the decoder may determine a weight applied to the current block by parsing the index information. Herein, N is an arbitrary positive integer. Herein, the index information may be configured to indicate the weight W_{IntraTMP} of the first prediction block or the weight W_{IBC} of the second prediction block.

Alternatively, the weight W_{IntraTMP} of the first prediction block and the weight W_{IBC} of the second prediction block may be derived from a neighboring reference block of a current block. Hereinafter, a method for determining weights of a first prediction block and a second prediction block from a reference block of a current block will be described.

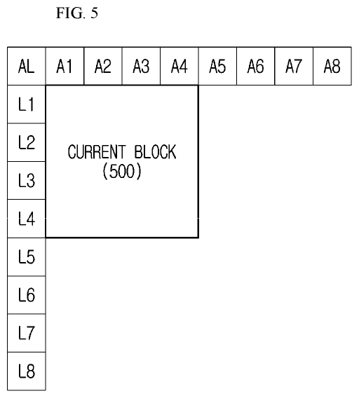

FIG. 5 shows a current block and a reference block referenced by the current block.

In FIG. 5, the size of neighboring reference blocks A1 to A8, L1 to L8 and AL of a current block 500 is a minimum size of a block that stores intra prediction mode information. Accordingly, although FIG. 5 describes reference blocks A1 to A4 on top of the current block 500 and reference blocks L1 to L4 to the left of the current block 500, a number of reference blocks other than four may be present on top of and to the left of the current block 500 according to a size of the current block 500. For example, when a block has a minimum size of 4×4 and the current block 500 has a size of 32×16, there may be eight reference blocks on top of the current block 500 and four reference blocks to the left of the current block 500.

Table 1 shows a method for determining a weight by using reference blocks A4 and L4 of the current block 500.

TABLE 1

| | |
|---|---|
| Types of intra prediction modes | Weights |

| A4 | L4 | W_{IntraTMP} | W_{IBC} |
|---|---|---|---|
| Intra template | Intra template | 3/4 | 1/4 |
| matching | matching | | |
| Intra template | Intra block copy | 2/4 | 2/4 |
| matching | | | |
| Intra block copy | Intra template | 2/4 | 2/4 |
| | matching | | |
| Intra block copy | Intra block copy | 1/4 | 3/4 |

As shown in Table 1, when both block A4 and block L4 have an intra prediction mode of intra template matching, W_{IntraTMP} may be set to be greater than W_{IBC}. On the other hand, when both block A4 and block L4 have intra block copy as a type of an intra prediction mode, W_{IBC} may be set to be greater than W_{IntraTMP}. When block A4 and block L4 have intra template matching and intra block copy, W_{IntraTMP} and W_{IBC} may be determined to be equal to each other. A weight set in Table 1 is merely one example, and another arbitrary value may be allocated to W_{IntraTMP} and W_{IBC}. The two reference blocks A4 and L4 are referenced to determine weights in Table 1, but a reference block at another position may be referenced for determination of a weight. According to an embodiment, W_{IntraTMP} and W_{IBC} may be determined according to M neighboring reference blocks of the current block 500. Herein, M is an arbitrary positive integer. W_{IntraTMP} and W_{IBC} may be calculated as shown in Equation 2 below.

$${W}_{IntraTMP} = \frac{{N}_{IntraTMP}}{M} , {W}_{IBC} = \frac{{N}_{I B C}}{M} \qquad [ Equation 2 ]$$

In Equation 2, N_{IntraTMP} and N_{IBC} mean the number of reference blocks, to which intra template matching is applied, and the number of reference blocks, to which intra block copy is applied, respectively, among M neighboring reference blocks of the current block 500. Herein, when a prediction mode of a reference block is neither an intra template matching mode nor an intra block copy mode, the reference block may be excluded from determination of a weight. Alternatively, when a prediction mode of a reference block is neither an intra template matching mode nor an intra block copy mode, the prediction mode of the reference block may be considered one of the intra template matching mode and the intra block copy mode to calculate W_{IntraTMP} and W_{IBC}. When the current block 500 is larger than a minimum size of a neighboring block, prediction information of the neighboring block may be deemed to be applicable to a plurality of reference blocks corresponding to the neighboring block. For example, when a neighboring block includes all reference blocks A1 to A4 and the neighboring block is predicted based on intra template matching, a prediction mode of reference blocks A1 to A4 may be considered an intra template matching mode. When a prediction mode of a reference block is a combined mode of intra template matching and intra block copy, the prediction mode of the reference block may be considered one of an intra template matching mode and an intra block copy mode. In addition, when a prediction mode of a reference block is a combined mode of regular intra prediction, intra template matching and intra block copy, the prediction mode of the reference block may be considered one of a regular intra prediction mode, an intra template matching mode and an intra block copy mode, which are used.

According to an embodiment, weight W_{IntraTMP} of a first prediction block and weight W_{IBC} of a second prediction block may be determined according to distortion of the first prediction block and distortion of the second prediction block. A distortion value of the first prediction block may be determined based on a difference between a current block and the first prediction block. In addition, a distortion value of the second prediction block may be determined based on a difference between the current block and the second prediction block.

Alternatively, the distortion value of the first prediction block may be determined based on a difference between a current template and a reference template. As shown in FIG. 4, the size and shape of a template for calculating a distortion value of a first prediction block according to intra template matching may be arbitrarily determined. L1 and L2, which determine a size of a template illustrated in FIG. 4, are arbitrary positive integers, and the template may include only a left reference sample, only a top reference sample, or both the left reference sample and the top reference sample. Likewise, a distortion value of a second prediction block may be determined based on a difference between a current template and a neighboring reference template of the matching block 420.

Herein, Equation 3 shows a method for calculating weight W_{IntraTMP} of a first prediction block and weight W_{IBC} of a second prediction block based on distortion of the first prediction block and distortion and the second prediction block.

$${W}_{IntraTMP} = \frac{{D}_{IBC}}{{D}_{IntraTMP} + {D}_{IBC}} , {W}_{IBC} = \frac{{D}_{IntraTMP}}{{D}_{IntraTMP} + {D}_{IBC}} \qquad [ Equation 3 ]$$

In Equation 3, D_{IntraTMP} and D_{IBC} represent a distortion value of a first prediction block according to intra template matching and a distortion value of a second prediction block according to intra block copy, respectively. The smaller the distortion value, the greater the similarity between a prediction signal and an original signal, and on the contrary, the greater the distortion value, the smaller the similarity between the prediction signal and the original signal. Accordingly, a weight of a prediction block may be determined in proportion to the reciprocal of a distortion value.

According to Equation 3, the weight of each prediction block may be calculated using a distortion value between different signals. Specifically, weight W_{IntraTMP} of a first prediction block according to intra template matching may be calculated using distortion value D_{IBC} of a second prediction block. In addition, weight W_{IBC} of a second prediction block according to intra block copy may be calculated using distortion value D_{IntraTMP} of a first prediction block. The distortion of each signal may be calculated by using various correlation measurement methods such as the sum of absolute differences (SAD) or the sum of square error (SSE).

For calculation of Equation 3, to reduce implementation complexity and computational complexity, all floating-point operations may be replaced with integer operations by using a look-up table (LUT). Through this approach, approximate values of the weights W_{IntraTMP} and W_{IBC} may be derived using only integer multiplication, addition, and shift operations, instead of floating-point operations. For example, a weight may be derived using an LUT of a cross-component linear model (CCLM).

According to an embodiment, when a distortion value of a first prediction block according to intra template matching and a distortion value of a second prediction block according to intra block copy are similar to each other, generating a final prediction block by using a weighted sum of the two prediction blocks may not be meaningful. Accordingly, when distortion values are determined to be similar as described above, an intra prediction mode combining intra template matching and intra block copy may not be applied to a current block. Instead, one of intra template matching and intra block copy may be applied to the current block. Herein, the distortion of each signal may be calculated by using various correlation measurement methods such as the sum of absolute differences (SAD) or the sum of square error (SSE). A similarity between distortion values may be determined using Equation 4 below.

$${D}_{max} - {D}_{min} \leq {Threshold}_{1} \qquad [ Equation 4 ]$$

Here, Dₘᵢₙ means a smaller distortion value between a distortion value of a first prediction block according to intra template matching and a distortion value of a second prediction block according to intra block copy. In addition, Dₘₐₓ means a larger distortion value between the distortion value of the first prediction block according to intra template matching and the distortion value of the second prediction block according to intra block copy. In addition, Threshold is an arbitrary positive real number. When Equation 4 is satisfied, that is, when a difference in distortion values between two prediction blocks is equal to or less than an arbitrary threshold, the two prediction blocks may be determined to be similar. Equation 4 is merely one example of determining a similarity, and a method for determining a similarity is not limited to Equation 4.

According to an embodiment, when there is a great difference between distortion value D_{IntraTMP} of a first prediction block according to intra template matching and distortion value D_{IBC} of a second prediction block according to intra block copy, a final prediction block may be generated, as shown in Equation 5, according to a weighted sum of a prediction block with the smaller distortion value between the two distortion values and a prediction block that is generated by Planar mode which is an intra prediction mode. Herein, the distortion of each signal may be calculated by using various correlation measurement methods such as the sum of absolute differences (SAD) or the sum of square error (SSE). Alternatively, even when a larger distortion value between distortion value D_{IntraTMP} of a first prediction block and distortion value D_{IBC} of a second prediction block according to intra block copy is greater than a predetermined threshold, a prediction block generated by Planar mode may be used instead of a prediction block with the larger distortion value. In addition, although Equation 5 uses the Planar mode of intra prediction, an arbitrary intra prediction mode other than the Planar mode may be used.

$$P = {W}_{min} \times {P}_{min} + {W}_{P l a n a r} \times {P}_{P l a n a r} \qquad [ Equation 5 ]$$

In Equation 5, Pₘᵢₙ represents a prediction signal with a smaller distortion value between a distortion value of a prediction signal derived based on intra template matching and a distortion value of a prediction signal derived based on intra block copy. In addition, P_{Planar} means a prediction signal generated by Planar mode. Wₘᵢₙ and Wₚₗₐₙₐᵣ represent a weight of the prediction signal with the smaller distortion value and a weight of the prediction signal generated by Planar mode respectively. In addition, the two weights satisfy Wₘᵢₙ+W_{Planar}=1, Wₘᵢₙ≥0, and W_{Planar}≥0. Wₘᵢₙ and Wₚₗₐₙₐᵣ may be arbitrary weights that are set beforehand at an encoder and a decoder.

Alternatively, Wₘᵢₙ and Wₚₗₐₙₐᵣ may be determined among N preset weight candidates. Herein, the encoder may transmit index information indicating a weight candidate applied to a current block among the N weight candidates, and the decoder may determine a weight applied to the current block by parsing the index information. Herein, N is an arbitrary positive integer. Herein, the index information may be configured to indicate weight Wₘᵢₙ of the prediction signal with the smaller distortion value or weight Wₚₗₐₙₐᵣ of the prediction signal according to Planar mode.

In addition, a difference between distortion values may be determined using Equation 6 below.

$${D}_{max} - {D}_{min} \leq {Threshold}_{2} \qquad [ Equation 6 ]$$

Here, Dₘᵢₙ means a smaller distortion value between a distortion value of a first prediction block according to intra template matching and a distortion value of a second prediction block according to intra block copy. In addition, Dₘₐₓ means a larger distortion value between the distortion value of the first prediction block according to intra template matching and the distortion value of the second prediction block according to intra block copy. In addition, Threshold₂ is an arbitrary positive real number. When the condition according to Equation 6 is satisfied, that is, when a difference in distortion values between two prediction signals is equal to or greater than an arbitrary threshold, it may be determined that omitting the prediction signal with the larger distortion value is advantageous. Equation 6 is merely one example of determining whether a difference in distortion values is great, and a method for determining a difference in distortion values is not limited to Equation 6.

Hereinafter, a method is described in which a current block is predicted by combining a first prediction block, which is derived by intra template matching, a second prediction block, which is derived by intra block copy, and a third prediction block generated from a regular intra prediction mode. The regular intra prediction mode is an intra prediction mode using an adjacent reference sample of a current block and may include a Planar mode, a DC mode, and a directional intra prediction mode.

As described above, a first prediction block is generated by the matching block 410 according to intra template matching, and a second prediction block is generated by the matching block 420 according to intra block copy. According to an embodiment, in addition, a third prediction according to regular intra prediction may be generated based on reference samples adjacent to the current block 400. In addition, a final prediction block of the current block 400 may be determined based on a weighted sum of the first prediction block, the second prediction block and the third prediction block. Equation 7 below shows a method for determining a final prediction block of a current block according to a weighted sum of a first prediction block according to intra template matching, a second prediction block according to intra block copy, and a third prediction block according to regular intra prediction.

$$P = {W}_{IntraMode} \times {P}_{IntraMode} + {W}_{IntraTMP} \times {P}_{IntraTMP} + {W}_{IBC} \times {P}_{IBC} \qquad [ Equation 7 ]$$

In Equation 7, P_{IntraMode}, P_{IntraTMP} and P_{IBC} mean a prediction signal according to regular intra prediction, a prediction signal according to intra template matching, and a prediction signal according to intra block copy, respectively. W_{IntraMode}, W_{IntraTMP} and W_{IBC} are a weight of the prediction signal according to regular intra prediction, a weight of the prediction signal according to intra template matching, and a weight of the prediction signal according to intra block copy, respectively. Herein, W_{IntraMode}+W_{IntraTMP}+W_{IBC}=1, W_{IntraMode}≥0, W_{IntraTMP}≥0, and W_{IBC}≥0.

According to an embodiment, a final prediction block may be generated by a weighted sum of K first blocks derived based on intra template matching, one second prediction block derived based on intra block copy, and one third prediction block generated from a regular intra prediction mode. Herein, the K prediction blocks derived according to intra template matching may be determined in ascending order of distortions of templates. Herein, K is an arbitrary positive integer.

According to an embodiment, K first prediction blocks, one second prediction block, and one third prediction block may have a same weight. Alternatively, the sum of weights of the K first prediction blocks may be set to be equal to a weight of the one second prediction block or a weight of the one third prediction block. In addition, a same weight may be set for each of the K first prediction blocks. Alternatively, a different weight may be set for each of the K first prediction blocks according to a distortion of a template. For example, a small weight may be given to a first prediction block that is generated from a template with a large distortion value. The distortion of the template may be calculated by using various correlation measurement methods such as the sum of absolute differences (SAD) or the sum of square error (SSE).

According to an embodiment, weight W_{IntraTMP} of a first prediction block according to intra template matching, weight W_{IBC} of a second prediction block according to intra block copy, and weight W_{IntraMode} of a third prediction block according to a regular intra prediction mode may be determined as arbitrary weights that are preset at an encoder and a decoder.

Alternatively, weight W_{IntraTMP} of a first prediction block, weight W_{IBC} of a second prediction block, and weight W_{IntraMode} of a third prediction block may be determined among N predefined weight candidates. Herein, the encoder may transmit index information indicating a weight candidate applied to a current block among the N weight candidates, and the decoder may determine a weight applied to the current block by parsing the index information. Herein, N is an arbitrary positive integer. Herein, the index information may include weight W_{IntraTMP} of the first prediction block, weight W_{IBC} of the second prediction block, and weight W_{IntraMode} of the third prediction block.

Alternatively, weight W_{IntraTMP} of the first prediction block, weight W_{IBC} of the second prediction block, and weight W_{IntraMode} of the third prediction block may be derived from a neighboring reference block of a current block. Hereinafter, a method for determining weights of a first prediction block, a second prediction block and a third prediction block from a reference block of a current block will be described.

Table 2 shows a method for determining a weight by using neighboring reference blocks A4 and L4 of the current block of FIG. 5.

TABLE 2

| Types of intra prediction modes | | Weights | | |
|---|---|---|---|---|
| A4 | L4 | W_{IntraMode} | W_{IntraTMP} | W_{IBC} |
| Intra prediction | Intra prediction mode | 6/8 | 1/8 | 1/8 |
| mode | | | | |
| Intra prediction | Intra template | 3/8 | 3/8 | 2/8 |
| mode | matching | | | |
| Intra prediction | Intra block copy | 3/8 | 2/8 | 3/8 |
| mode | | | | |
| Intra template | Intra template | 1/8 | 6/8 | 1/8 |
| matching | matching | | | |
| Intra template | Intra prediction mode | 3/8 | 3/8 | 2/8 |
| matching | | | | |
| Intra template | Intra block copy | 2/8 | 3/8 | 3/8 |
| matching | | | | |
| Intra block copy | Intra block copy | 1/8 | 1/8 | 6/8 |
| Intra block copy | Intra prediction mode | 3/8 | 2/8 | 3/8 |
| Intra block copy | Intra template | 2/8 | 3/8 | 3/8 |
| | matching | | | |

As shown in Table 2, a greater weight may be allocated to a prediction block that is derived according to intra prediction modes of block A4 and block L4. The weights of Table 2 are merely examples, and a different arbitrary weight may be allocated to each prediction block. According to an embodiment, W_{IntraTMP}, W_{IBC} and W_{IntraMode} may be determined according to M neighboring reference blocks of the current block 500. Herein, M is an arbitrary positive integer. W_{IntraTMP}, W_{IBC} and W_{IntraMode} may be calculated as shown in Equation 8 below.

$${W}_{IntraMode} = \frac{{N}_{IntraMode}}{M} , {W}_{IntraTMP} = \frac{{N}_{IntraTMP}}{M} , {W}_{IBC} = \frac{{N}_{IBC}}{M} \qquad [ Equation 8 ]$$

In Equation 8, N_{IntraMode}, N_{IntraTMP} and N_{IBC} mean the number of reference blocks, to which regular intra prediction is applied, the number of reference blocks, to which intra template matching is applied, and the number of reference blocks, to which intra block copy is applied, respectively, among M neighboring reference blocks of the current block 500. Herein, when a prediction mode of a reference block is not a regular intra prediction mode, an intra template matching mode, or an intra block copy mode, the reference block may be excluded. Alternatively, when a prediction mode of a reference block is not a regular intra prediction mode, an intra template matching mode, or an intra block copy mode, the prediction mode of the reference block may be considered one of the regular intra prediction mode, the intra template matching mode, and the intra block copy mode to calculate N_{IntraMode}, N_{IntraTMP} and N_{IBC}. When the current block 500 is larger than a minimum size of a neighboring block, prediction information of the neighboring block may be deemed to be applicable to a plurality of reference blocks corresponding to the neighboring block. For example, when a neighboring block includes all reference blocks A1 to A4 and the neighboring block is predicted based on intra template matching, a prediction mode of reference blocks A1 to A4 may be considered an intra template matching mode. When a prediction mode of a reference block is a combined mode of intra template matching and intra block copy, the prediction mode of the reference block may be considered one of an intra template matching mode and an intra block copy mode. In addition, when a prediction mode of a reference block is a combined mode of regular intra prediction, intra template matching and intra block copy, the prediction mode of the reference block may be considered one of a regular intra prediction mode, an intra template matching mode and an intra block copy mode, which are used.

According to an embodiment, W_{IntraTMP}, W_{IBC} and W_{IntraMode} may be determined according to distortion of a first prediction block, distortion of a second prediction block, and distortion of a third prediction block. A distortion value of the first prediction block may be determined based on a difference between a current block and the first prediction block. In addition, a distortion value of the second prediction block may be determined based on a difference between the current block and the second prediction block. In addition, a distortion value of the third prediction block may be determined based on a difference between the current block and the third prediction block. Alternatively, as described above, the distortion value of the first prediction block may be determined based on a difference between a current template and a reference template. In addition, the distortion value of the second prediction block may be determined based on a difference between the current template and a template of the second prediction block. W_{IntraTMP}, W_{IBC} and W_{IntraMode} may each be determined to be proportional to the reciprocal of a distortion value. Accordingly, a greater weight may be given to a prediction block with a smaller distortion value.

According to an embodiment, when a distortion value of a first prediction block according to intra template matching and a distortion value of a second prediction block according to intra block copy are similar to each other, generating a final prediction block by using a weighted sum of the two prediction blocks may not be meaningful. Accordingly, when distortion values are determined to be similar as described above, an intra prediction mode combining regular intra prediction, intra template matching and intra block copy may not be applied to a current block. Instead, one of regular intra prediction, intra template matching and intra block copy may be applied to the current block. Herein, the distortion of each signal may be calculated by using various correlation measurement methods such as the sum of absolute differences (SAD) or the sum of square error (SSE). A similarity between distortion values may be determined using Equation 9 below.

$${D}_{max} - {D}_{min} \leq {Threshold}_{3} \qquad [ Equation 9 ]$$

Here, Dₘᵢₙ means a smaller distortion value between a distortion value of a first prediction block according to intra template matching and a distortion value of a second prediction block according to intra block copy. In addition, Dₘₐₓ means a larger distortion value between the distortion value of the first prediction block according to intra template matching and the distortion value of the second prediction block according to intra block copy. In addition, Threshold₃ is an arbitrary positive real number. When Equation 9 is satisfied, that is, when a difference in distortion values between two prediction blocks is equal to or less than an arbitrary threshold, the two prediction blocks may be determined to be similar. Equation 9 is merely one example of determining a similarity, and a method for determining a similarity is not limited to Equation 9.

According to an embodiment, when there is a great difference between distortion value D_{IntraTMP} of a first prediction block according to intra template matching and distortion value D_{IBC} of a second prediction block according to intra block copy, a final prediction block may be generated, as shown in Equation 10, according to a weighted sum of a prediction block generated by regular intra prediction, a prediction block with the smaller distortion value between the two distortion values, and a prediction block that is generated by Planar mode which is an intra prediction mode. Herein, the distortion of each signal may be calculated by using various correlation measurement methods such as the sum of absolute differences (SAD) or the sum of square error (SSE). Alternatively, even when a larger distortion value between distortion value D_{IntraTMP} of a first prediction block and distortion value D_{IBC} of a second prediction block according to intra block copy is greater than a predetermined threshold, a prediction block generated by Planar mode may be used instead of a prediction block with the larger distortion value. In addition, although Equation 10 uses the Planar mode of intra prediction, an arbitrary intra prediction mode other than the Planar mode may be used.

$$P = {W}_{IntraMode} \times {P}_{IntraMode} + {W}_{min} \times {P}_{min} + {W}_{Planar} \times {P}_{Planar} \qquad [ Equation 10 ]$$

In Equation 10, P_{IntraMode} represents a prediction signal that is generated based on a regular intra prediction mode. In addition, Pₘᵢₙ represents a prediction signal with a smaller distortion value between a distortion value of a prediction signal derived based on intra template matching and a distortion value of a prediction signal derived based on intra block copy. In addition, P_{Planar} means a prediction signal generated by Planar mode. W_{IntraMode}, Wₘᵢₙ, and W_{Planar} represent a weight of a prediction signal generated from an intra prediction mode, a weight of a prediction signal with a smaller distortion value, and a weight of a prediction signal generated by Planar mode, respectively. In addition, the three weights satisfy W_{IntraMode}+Wₘᵢₙ+W_{Planar}=1, W_{IntraMode}≥0, Wₘᵢₙ≥0, and W_{Planar}≥0. W_{IntraMode}, Wₘᵢₙ and W_{Planar} may be arbitrary weights that are set beforehand at an encoder and a decoder.

Alternatively, W_{IntraMode}, Wₘᵢₙ and W_{Planar} may be determined among N preset weight candidates. Herein, the encoder may transmit index information indicating a weight candidate applied to a current block among the N weight candidates, and the decoder may determine a weight applied to the current block by parsing the index information. Herein, N is an arbitrary positive integer. Herein, the index information may be configured to indicate weight W_{IntraMode} of the prediction signal according to a regular intra prediction mode, weight Wₘᵢₙ of the prediction signal with the smaller distortion value, or weight Wₚₗₐₙₐᵣ of the prediction signal according to Planar mode.

In the above-described method, a difference in weight values may be determined according to Equation 11.

$${D}_{max} - {D}_{min} \leq {Threshold}_{4} \qquad [ Equation 11 ]$$

Here, Dₘᵢₙ means a smaller distortion value between a distortion value of a first prediction block according to intra template matching and a distortion value of a second prediction block according to intra block copy. In addition, Dₘₐₓ means a larger distortion value between the distortion value of the first prediction block according to intra template matching and the distortion value of the second prediction block according to intra block copy. In addition, Threshold₄ is an arbitrary positive real number. When the condition according to Equation 11 is satisfied, that is, when a difference in distortion values between two prediction signals is equal to or greater than an arbitrary threshold, it may be determined that omitting the prediction signal with the larger distortion value is advantageous. Equation 11 is merely one example of determining whether a difference in distortion values is great, and a method for determining a difference in distortion values is not limited to Equation 11.

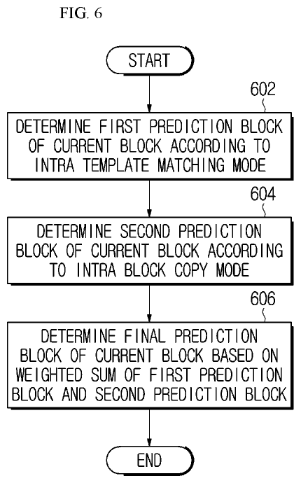

FIG. 6 is a flowchart showing an embodiment of an intra prediction method according to the present invention.

At step S602, a first prediction block of a current block is determined according to an intra template matching mode.

At step S604, a second prediction block of the current block is determined according to an intra block copy mode.

At step S606, a final prediction block of the current block is determined based on a weighted sum of the first prediction block and the second prediction block. Embodiments described below may be applied in order to determine the final prediction block of step S606.

According to an embodiment, a first weight of the first prediction block and a second weight of the second prediction block, which are used to calculate the weighted sum of the first prediction block and the second prediction block, may be determined. As an example, the first weight and the second weight may be selected among a plurality of weight candidates, based on weight information obtained from a bitstream. Weight information indicating the first weight and the second weight among the plurality of weight candidates may be encoded at an encoder, and one of the plurality of weight candidates may be selected at a decoder according to the weight information. When a weighted sum of three or more prediction blocks is calculated, the weight information may include not only the first weight and the second weight but also information on an additional weight.

Alternatively, according to an embodiment, the first weight and the second weight may be determined according to a prediction mode that is applied to a predetermined reference block adjacent to the current block. For example, the predetermined reference block may include a top block at a predetermined top position of the current block and a left block at a predetermined left position of the current block, and the first weight and the second weight may be determined according to a prediction mode applied to the top block and a prediction mode applied to the left block. Herein, when both the top block and the left block are predicted according to the intra template matching mode, the first weight may have a greater value than the second weight, when both the top block and the left block are predicted according to the intra block copy mode, the second weight may have a greater value than the first weight, and when one of the top block and the left block is predicted according to the intra template matching mode and the other of the top block and the left block is predicted according to the intra block copy mode, the first weight and the second weight may be set to have a same value.

According to an embodiment, the predetermined reference block may include one or more top blocks adjacent to the top of the current block and one or more left blocks adjacent to the left of the current block, and the first weight and the second weight may be determined according to a prediction mode applied to the one or more top blocks and to the one or more left blocks. According to an embodiment, the first weight and the second weight may be determined to be proportional, respectively, to the number of intra template matching mode blocks and the number of intra block copy mode blocks applied to the one or more top blocks and the one or more left blocks.

According to an embodiment, when the predetermined reference block is predicted using a prediction mode other than the intra block copy mode or the intra template matching mode, the predetermined reference block may be excluded from determination of the first weight and the second weight. Alternatively, when the predetermined reference block is predicted using a prediction mode other than the intra block copy mode or the intra template matching mode, during the determination of the first weight and the second weight, the predetermined reference block may be considered as being predicted by one of the intra block copy mode and the intra template matching mode.

According to an embodiment, the first weight of the first prediction block and the second weight of the second prediction block, which are used to calculate the weighted sum of the first prediction block and the second prediction block, may be determined according to a first distortion value of the first prediction block and a second distortion value of the second prediction block. In addition, the first distortion value of the first prediction block may be derived based on a difference between the current block and the first prediction block or a difference between a current template of the current block and a reference template that is used to derive the first prediction block, and the second distortion value of the second prediction block may be derived based on a difference between the current block and the second prediction block or a difference between the current template of the current block and a template of the second prediction block. In addition, the first weight and the second weight may be determined to be proportional to the reciprocal of a first distortion value and the reciprocal of a second distortion value, respectively.

According to an embodiment, when a difference between the first distortion value and the second distortion value is greater than a predetermined limit value, a third prediction block that is predicted using a predetermined regular intra prediction mode may be used for determination of the final prediction block, instead of a prediction block corresponding to the larger distortion value between the first prediction block and the second prediction block. The predetermined regular intra prediction mode may be one of the Planar mode, the DC mode, and predetermined directional modes.

According to an embodiment, the method for decoding the image may further include determining the third prediction block of the current block according to a regular intra prediction mode, and the final prediction block of the current block may be determined based on a weighted sum of the first prediction block, the second prediction block and the third prediction block.

According to the prediction method performed at step S602 to step S606, the current block may be encoded or decoded. In addition, a bitstream generated by an encoder according to the prediction method performed at step S602 to step S606 may be stored in a recoding medium or transmitted outside the encoder.

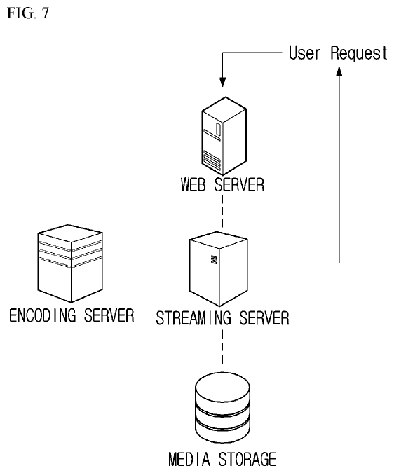

FIG. 7 exemplary illustrates a content streaming system to which an embodiment according to the present disclosure is applicable.

As illustrated in FIG. 7, a content streaming system to which an embodiment of the present disclosure is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present disclosure is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the invention, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the invention.

### INDUSTRIAL APPLICABILITY

The present disclosure may be used in an apparatus for encoding/decoding an image and a recording medium for storing a bitstream.

1. A method for decoding an image, the method comprising:
determining a first prediction block of a current block according to intra template matching mode;
determining a second prediction block of the current block according to intra block copy mode; and
determining a final prediction block of the current block based on a weighted sum of the first prediction block and the second prediction block.

2. The method of claim 1, wherein a first weight of the first prediction block and a second weight of the second prediction block, which are used to calculate the weighted sum of the first prediction block and the second prediction block, are selected among a plurality of weight candidates based on weight information obtained from a bitstream.

3. The method of claim 1, wherein the first weight of the first prediction block and the second weight of the second prediction block, which are used to calculate the weighted sum of the first prediction block and the second prediction block, are determined according to a prediction mode that is applied to a predetermined reference block adjacent to the current block.

4. The method of claim 3, wherein when the predetermined reference block is predicted using a prediction mode other than the intra block copy mode or the intra template matching mode, the predetermined reference block is excluded from determination of the first weight and the second weight.

5. The method of claim 3, wherein when the predetermined reference block is predicted using a prediction mode other than the intra block copy mode or the intra template matching mode, during the determination of the first weight and the second weight, the predetermined reference block is considered as being predicted by one of the intra block copy mode and the intra template matching mode.

6. The method of claim 3, wherein the predetermined reference block includes a top block at a predetermined top position of the current block and a left block at a predetermined left position of the current block, and
wherein the first weight and the second weight are determined according to a prediction mode applied to the top block and a prediction mode applied to the left block.

7. The method of claim 6, wherein when both the top block and the left block are predicted according to the intra template matching mode, the first weight has a greater value than the second weight,
wherein when both the top block and the left block are predicted according to the intra block copy mode, the second weight has a greater value than the first weight, and
wherein when one of the top block and the left block is predicted according to the intra template matching mode and the other of the top block and the left block is predicted according to the intra block copy mode, the first weight and the second weight are set to have a same value.

8. The method of claim 3, wherein the predetermined reference block includes one or more top blocks adjacent to the top of the current block and one or more left blocks adjacent to the left of the current block, and
wherein the first weight and the second weight are determined according to a prediction mode applied to the one or more top blocks and to the one or more left blocks.

9. The method of claim 8, wherein the first weight and the second weight are determined to be proportional, respectively, to the number of intra template matching mode blocks and the number of intra block copy mode blocks applied to the one or more top blocks and the one or more left blocks.

10. The method of claim 1, wherein the first weight of the first prediction block and the second weight of the second prediction block, which are used to calculate the weighted sum of the first prediction block and the second prediction block, are determined according to a first distortion value of the first prediction block and a second distortion value of the second prediction block.

11. The method of claim 10, wherein the first distortion value of the first prediction block is derived based on a difference between the current block and the first prediction block or a difference between a current template of the current block and a reference template that is used to derive the first prediction block, and
wherein the second distortion value of the second prediction block is derived based on a difference between the current block and the second prediction block or a difference between the current template of the current block and a template of the second prediction block.

12. The method of claim 10, wherein the first weight and the second weight are determined to be proportional to a reciprocal of the first distortion value and a reciprocal of the second distortion value, respectively.

13. The method of claim 10, wherein when a difference between the first distortion value and the second distortion value is greater than a predetermined limit value, a third prediction block that is predicted using a predetermined regular intra prediction mode is used for determination of the final prediction block, instead of a prediction block corresponding to a larger distortion value between the first prediction block and the second prediction block.

14. The method of claim 1, further comprising
determining the third prediction block of the current block according to a regular intra prediction mode,
wherein the final prediction block of the current block is be determined based on a weighted sum of the first prediction block, the second prediction block and the third prediction block.

15. A method for encoding an image, the method comprising:
determining a first prediction block of a current block according to intra template matching mode;
determining a second prediction block of the current block according to intra block copy mode; and
determining a final prediction block of the current block based on a weighted sum of the first prediction block and the second prediction block.

16. A computer-readable recording medium for storing a bitstream generated by a method for encoding an image,
wherein the method for encoding an image comprises:
determining a first prediction block of a current block according to intra template matching mode;
determining a second prediction block of the current block according to intra block copy mode; and
determining a final prediction block of the current block based on a weighted sum of the first prediction block and the second prediction block.

17. (canceled)
